(19) United States
(12) Patent Application Publication
(10) Pub. No.: US 2005/0211037 A1
(43) Pub. Date: Sep. 29, 2005

(54) Punch capable of punching and embossing object at two directions respectively

(76) Inventor: Wan-Young Oh, Seoul (KR)

Correspondence Address: JONES DAY, 222 EAST 41ST ST, NEW YORK, NY, 10017, US

(21) Appl. No.: 10/887,527

(22) Filed: Jul. 7, 2004

(30) Foreign Application Priority Data
Mar. 26, 2004 (KR) 20-2004-0008481

(51) Int. Cl. B26F 1/14

(52) U.S. Cl. 83/467.1; 83/686; 72/464

(57) ABSTRACT

A punch capable of punching and embossing a rectangular corner of a sheet member at two directions of a jig is disclosed. The punch includes a jig having two punching regions symmetrically disposed on the basis of a punching center so that a main pattern hole is formed in one punching region and a convex embossment is formed on the other punching region; a base for fixing the jig and giving a supply surface so that a rectangular corner of a sheet member to be punched is supplied to the punching region; a punching member having a punch pin and a concave embossment corresponding to the pattern hole and the convex embossment, and punching and/or embossing the rectangular corner of the supplied sheet member with vertically moving against the jig; and an elastic body interposed between the punching member and the jig to elastically bias the punching member upward.

### BACKGROUND OF THE INVENTION

1. Field of the Invention

The present invention relates to a punch for punching a sheet member, and more particularly to a punch capable of punching and embossing a rectangular corner of a sheet member in a desired pattern according to the selection of a user when the user punches a rectangular corner of the sheet member such as a card, a letter paper, a picture, a board or a paper.

2. Description of the Related Art

A punch generally includes a jig 10 having a hole 10a of a predetermined pattern, a base 20 for supporting the jig 10 below it, and a cutting member 30 having a sharp blade sliding through the hole 10a of the jig 10, as schematically shown in FIG. 1. The punch performs punching a specific portion of a sheet member 1 according to the pattern of the hole 10a of the jig 10.

In a general punch, only one hole 10a is formed in the jig 10 in correspondence to a pattern to be perforated. Thus, the conventional punch is just capable of punching a specific portion of the sheet member 1, not forming an embossing pattern which is widely used for decoration of various sheet members 1.

In addition, in a punching work for decorating a rectangular corner of a sheet member such as a letter paper, a photograph or a board, it is important to set the sheet member to a punching point accurately. However, the conventional punch is not equipped with such function, so the punching patterns are apt to be irregular.

### SUMMARY OF THE INVENTION

The present invention is designed to solve the problems of the prior art, and therefore it is an object of the present invention to provide a punch, which is capable of conveniently punching and/or embossing a rectangular corner of a sheet member according to the selection of a user, by having separate work regions so that a punching work is performed at a portion of the jig and an embossing work is performed at another portion of the jig.

Another object of the present invention is to provide a punch having two punching regions for punching and/or embossing a sheet member as a user selects, and having only one punch pin for punching an edge portion of the corner of of the sheet member in a predetermined pattern so that the punch pin may be commonly used in both punching regions.

In order to accomplish the above object, the present invention provides a punch, which includes a jig having two punching regions symmetrically disposed on the basis of a punching center so that a main pattern hole of a predetermined pattern is formed in one punching region and a convex embossment (or, a concave embossment) is formed on the other punching region; a base to which the jig is fixed, the base giving a supply surface so that a rectangular corner of a sheet member to be punched is supplied to the punching region; a punching member having a punch pin and a concave embossment (or, a convex embossment) corresponding to the pattern hole and the convex embossment (or, the concave embossment), the punching member punching and/or embossing the rectangular corner of the supplied sheet member with moving up and down against the jig; and an elastic body interposed between the punching member and the jig to elastically bias the punching member upward.

Preferably, a guide is further formed on an upper surface of the base in order to guide both edges of the rectangular corner so that the rectangular corner of the sheet member is put into each punching region of the jig.

In addition, the punch of the present invention may further include a button member combined above the punching member for acting as a contact portion pressed by hand; and a cap for wrapping the button member, the punching member and the elastic body.

The jig may additionally have an edge pattern hole formed integrally over both punching regions of the jig so that an edge portion of the rectangular corner of the sheet member supplied to each punching region is punched, and the punching member may further include an edge punch pin corresponding to the edge punch hole.

Preferably, the edge punch pin includes a first cutting blade for cutting the edge portion of the sheet member supplied to one punching region along a predetermined punching line; and a second cutting blade for cutting the edge portion of the sheet member supplied to the other punching region, the second cutting blade cutting a point between a virtual punching line symmetrical to an edge punching line of one punching region on the basis of the punching center and a central line passing through the punching center and crossing a midway of both punching lines.

The second cutting blade is preferably positioned between the virtual punching line and the central line and also preferably has a curved shape for cutting along a virtual arc passing through the punching center.

### BRIEF DESCRIPTION OF THE DRAWINGS

Other objects and aspects of the present invention will become apparent from the following description of embodiments with reference to the accompanying drawing in which:

FIG. 1 is a side sectional view showing a punch according to the prior art;

FIG. 2 is a perspective view showing an appearance of a punch according to a preferred embodiment of the present invention, which is in an assembled state;

FIG. 3 is an exploded perspective view showing a punch according to a preferred embodiment of the present invention;

FIG. 4 is a perspective view showing an example of a punching member of FIG. 3;

FIG. 5 is a plane view showing an example of an edge punching line and a virtual symmetric punching line formed by the punch of the present invention;

FIG. 6 is a plane view showing a surplus area of a sheet member, which is obtained by an edge punch pin provided according to one embodiment of the present invention;

FIG. 7 is a plane view showing a surplus area of a sheet member, which is obtained by an edge punch pin provided according to another embodiment of the present invention;

FIG. 8 is a schematic plane view showing that a sheet member is supplied to the punch according to a preferred embodiment of the present invention;

FIG. 9 is a plane view showing that a rectangular corner of the sheet member is punched by the punch according to a preferred embodiment of the present invention; and

FIG. 10 is a plane view showing that a rectangular corner of the sheet member is embossed by the punch according to a preferred embodiment of the present invention.

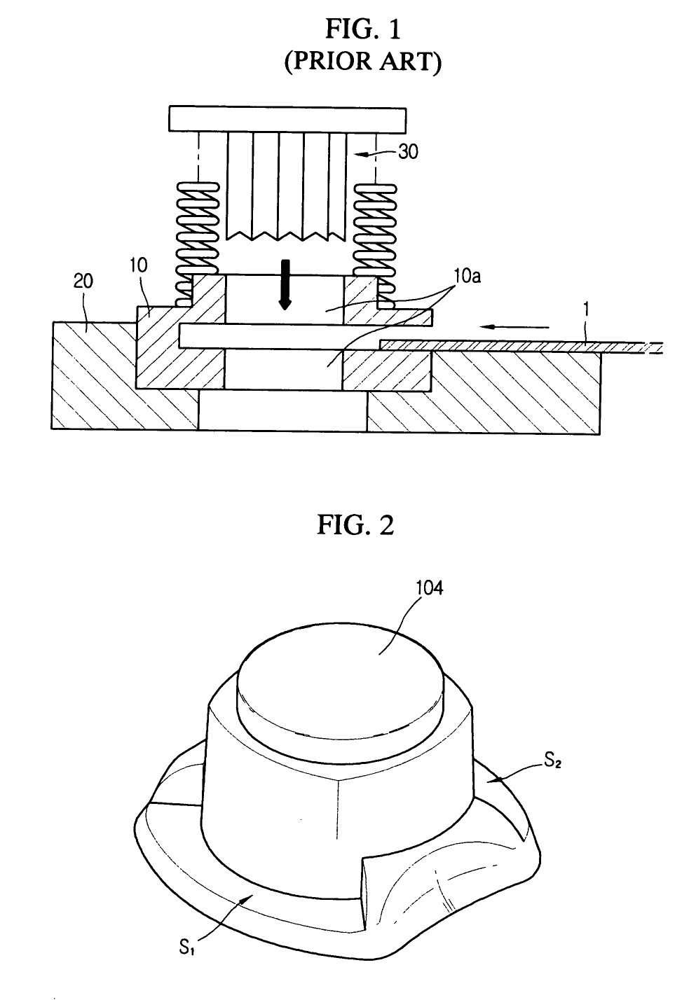

### DESCRIPTION OF THE PREFERRED EMBODIMENT

Hereinafter, the present invention will be described in more detail referring to the drawings.

FIG. 2 shows an appearance of a punch according to a preferred embodiment of the present invention. As shown in FIG. 2, in the punch of the present invention, two sheet member supply regions S₁ and S₂ are prepared on a base 101 symmetrically to give a supply surface of a sheet member for the punching and embossing work. A button member 104 is installed above the body so as to be movable up and down. By using this configuration, a punching pattern or an embossing pattern of a predetermined design may be formed when a user puts a rectangular corner of the sheet member to one of the sheet member supply regions S₁ and S₂ according to the selection of the user and then presses the button member 104 downward.

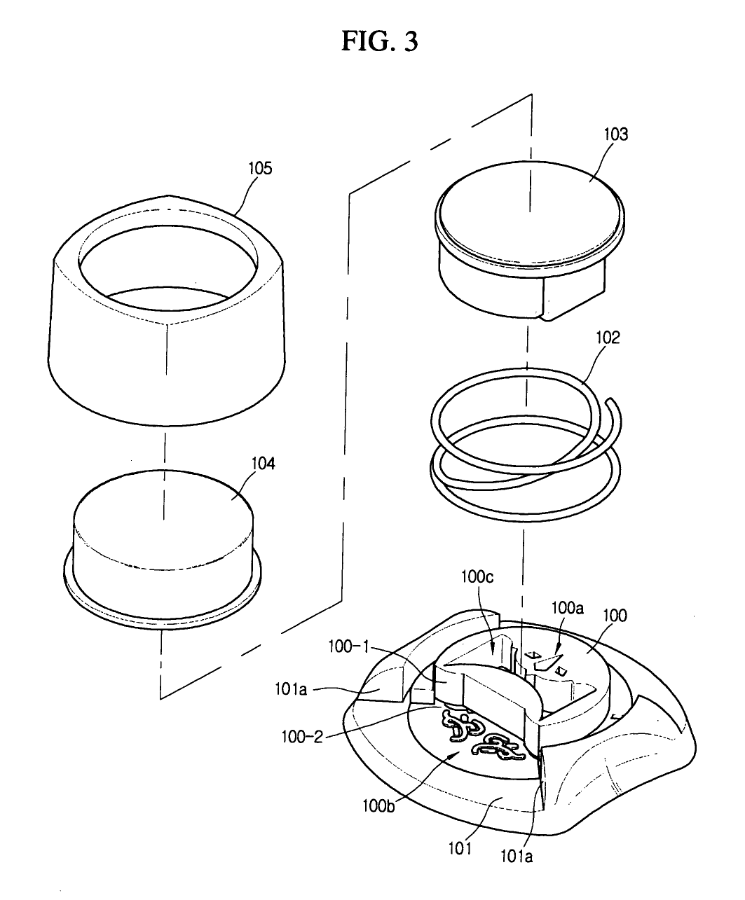

FIG. 3 shows the punch according to a preferred embodiment of the present invention in more detail.

Referring to FIG. 3, the punch of the present invention includes a jig 100 in which a main pattern hole 100a and a convex embossment 100b are formed, a base 101 for supporting the jig 100 and having the sheet member supply regions S₁ and S₂ respectively corresponding to the main pattern hole 100a and the convex embossment 100b, a punching member 103 installed to be movable up and down against the jig 100, and an elastic body 102 for giving an elastic force to the punching member 103.

The jig 100 has two punching regions P₁ and P₂ (see FIG. 8), which are disposed symmetrically on the basis of a virtual punching center O (see FIG. 5). The punching regions P₁ and P₂ respectively have the main pattern hole 100a and the convex embossment 100b of a predetermined pattern. Here, the jig 100 is configured so that an upper plate 100-1 and a lower plate 100-2 are divided with a gap (not shown) into which a sheet member to be punched is put. The main pattern hole 100a is formed in the upper and lower plates 100-1 and 100-2, and the convex embossment 100b is formed on the surface of the lower plate 100-2 so as to be contacted with a corresponding portion of the punching member 103.

In the jig 100, it is preferable that an edge pattern hole 100c is additionally formed in a portion where two punching regions P₁ and P₂ are overlapped so that edge portions of the rectangular corner of the sheet member to be punched or embossed are punched in a predetermined pattern. The edge pattern hole 100c is preferably a single hole integrally formed over both punching regions P₁ and P₂.

The base 101 supports the jig 100 below it and gives a supply surface for supplying a sheet member to the punching regions P₁ and P₂. On the surface of the base 101, a guide 101a is preferably provided for guiding both edges of the corner of the sheet member. The guide 101a guides an insert direction of the sheet member so that the rectangular corner of the sheet member is positioned in correspondence to the corresponding punching region P₁ or P₂. The guide is preferably a projection protruded upward from the base 101.

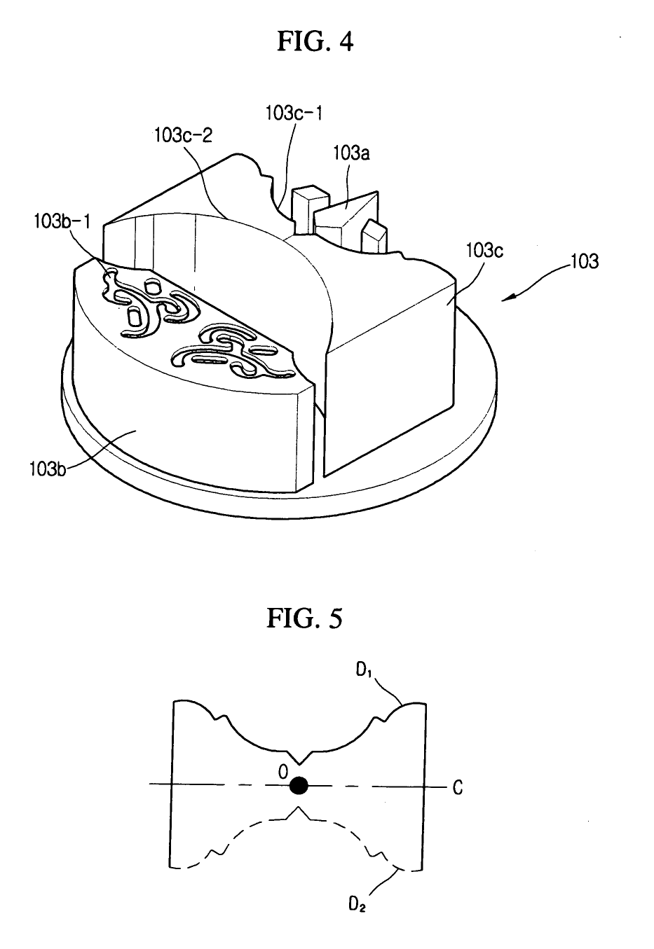

The punching member 103, well shown in FIG. 4, is installed to be movable up and down against the jig 100 and plays a role of punching and/or embossing the rectangular corner of the sheet member when it descends. For convenient handling of the punching member 103, an elastic body 102 for elastically biasing the punching member 103 upward is interposed between the punching member 103 and the jig 100.

In the punching member 103, punch pins 103a and 103b respectively corresponding to the main pattern hole 100a and the convex embossment 100b of the jig 100 as well as an edge punch pin 103c corresponding to the edge pattern hole 100c are protruded downward in an assembly.

In the punch pin assembly, the edge punch pin 103c corresponding to the edge pattern hole 100c has first and second cutting blades 103c-1 and 103c-2 respectively at both sides so that they may be commonly used for the sheet member put into the punching regions P₁ and P₂ on the jig 100. The first and second cutting blades 103c-1 and 103c-2 respectively punch an edge portion of each rectangular corner of the supplied sheet member in a predetermined pattern.

The first and second cutting blades 103c-1 and 103c-2 may be formed in a symmetrical pattern on the basis of the punching center O. More preferably, the first cutting blade 103c-1 corresponding to the punching region P₁ in which the main pattern hole 100a is formed may be formed to cut the edge portion of the sheet member along a punching line of a predetermined pattern with forming a decoration rim therein, while the second cutting blade 103c-2 corresponding to the punching region P₂ on which the convex embossment 100b is formed may be formed to cut the edge portion of the sheet member as much as an area smaller than a cut-away area made by the first cutting blade 103c-1.

More specifically, when cutting the edge portion of the supplied sheet member, the second cutting blade 103c-2 may be formed to cut a point between a virtual punching line D₂ symmetrical to an edge punching line D₁ formed by the first cutting blade 103c-1 on the basis of the punching center O and a central line C passing through the punching center O and crossing a midway of both punching lines D₁ and D₂, as shown in FIG. 5. For example, the second cutting blade 103c-2 may be formed in a curved shape as shown in FIG. 4 so as to cut along a virtual arc passing through the punching center O, while being positioned between the virtual punching line D₂ and the central line C.

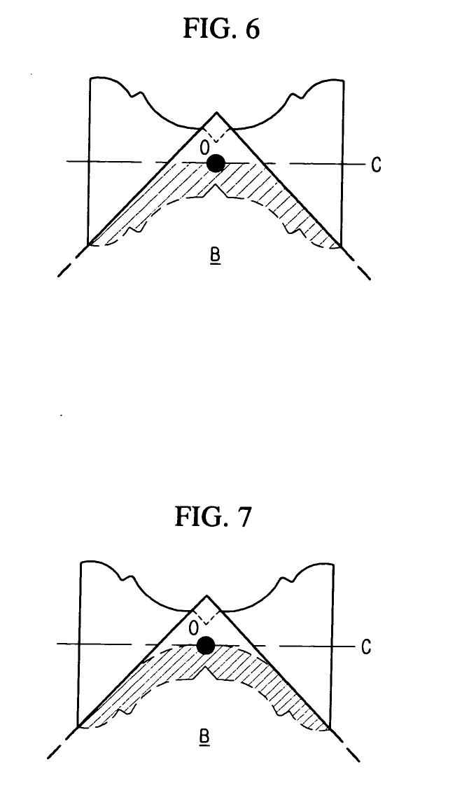

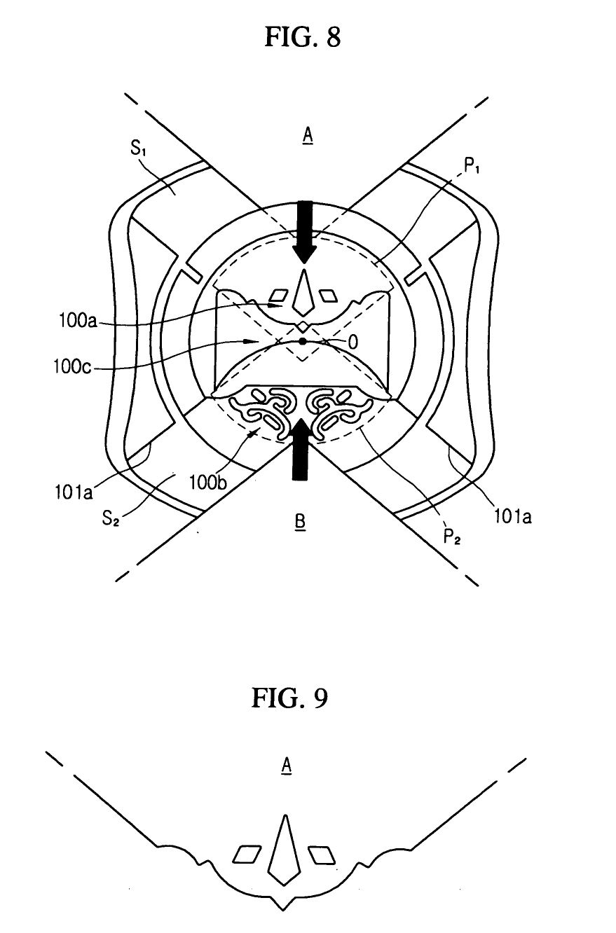

According to the edge punch pin 103c configured as above, a rectangular corner of a sheet member supplied to the punching region P₂ on which the convex embossment 100b is formed is firstly embossed, and then the sheet member is supplied to the punching region P₁. Thus, if a decoration rim is formed in the edge portion of the sheet member, a surplus area is sufficiently ensured for easy cutting work. FIG. 6 shows the surplus area of the rectangular corner of the sheet member B, which is obtained when the second cutting blade 103c-2 cuts the central line C, with the use of hatching, while FIG. 7 shows the surplus area of the rectangular corner of the sheet member B, which is obtained when the second cutting blade 103c-2 cuts the virtual arc, with the use of hatching.

In the punch pin assembly, the punch pin 103b corresponding to the convex embossment 100b of the jig 100 has a concave embossment 103b-1 at its end surface so that it is compressed with the convex embossment 100b of the jig 100 when the punching member 103 descends. In the present invention, if a concave embossment is formed on the jig 100, the punch pin has a convex embossment on its end surface, of course.

According to the above configuration, the punching pins 103a and 103c are correspondingly inserted into the main pattern hole 100a and the edge pattern hole 100c, thereby guiding vertical movement of the punching member 103. In addition, as the punching member 103 descends, the punch pin assembly descends toward the jig 100, thereby punching and/or embossing the rectangular corner of the sheet member.

Additionally, the button member 104 is combined above the punching member 103, so the button member 104 presses the punching member 103 downward when a user presses it by hand. The button member 104 is covered by a cap 105, which is combined with the base 101 with an open top, so an upper portion of the button member 104 is partially exposed. A rim portion of the button member 104 around the exposed upper portion is supported by the cap 105 so as to prevent the button member 104 from being deviated out due to an elastic force applied to the punching member 103. Here, the cap 105 is combined to the lower base 101 with covering not only the button member 104 but also the punching member 103 and the elastic body 102 below it in a bundle.

Now, operation of the punch configured as above according to the present invention is described.

First, a user selects one of the sheet member supply region S₁ or S2 according to the fact that a rectangular corner of the sheet member is to be punched or embossed. Then, the user supplies the sheet member so that both edges of the corner of the sheet member are guided by the guide 101a provided to the base 101 as shown in FIG. 8, then the rectangular corner of the sheet member may be easily and accurately arranged to the corresponding punching region P₁ or P₂. FIG. 8 shows that the sheet member A is supplied so as to punch the corner portion thereof in a predetermined pattern together with punching edge portions of the rectangular corner of the sheet member A, and that the sheet member B is supplied so as to punch the edge portion thereof in a predetermined pattern together with embossing the rectangular corner of the sheet member B.

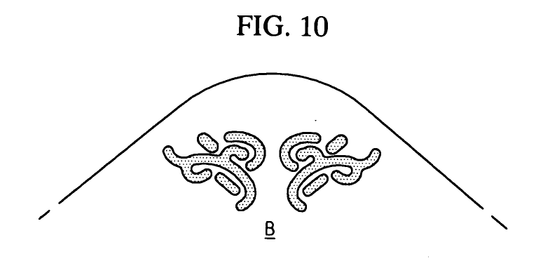

After the sheet member is put to the corresponding punching region P₁ or P₂ of the jig 100, a user presses the button member 104 down. Then, the punching member 103 pressed by the button member 104 is descended, so each of the punch pins 103a, 103b and 103c punches or embosses a corresponding portion of the sheet member. FIG. 9 shows a sheet member A in which a punching pattern is formed by the punch pin 103a, passing through the rectangular corner of the sheet member A, corresponding to the main pattern hole 100a, and an edge portion is cut away in a predetermined pattern by the punching pin 103c corresponding to the edge pattern hole 100c, according to descending movement of the punching member 103. In addition, FIG. 10 shows a sheet member B in which an uneven embossing pattern is formed when the punch pin 103b corresponding to the convex embossment 100b of the jig 100 is compressed with the convex embossment 100b of the jig 100 with the rectangular corner of the sheet member B interposed therebetween, and an edge portion of the rectangular corner is cut in a predetermined pattern by the punch pin 103c corresponding to the edge pattern hole 100c.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

The punch according to the present invention has a punching configuration and an embossing configuration separately, so it is capable of giving various decoration effects by associating the punching work and the embossing work for the rectangular corner of the sheet member.

In addition, the punch of the present invention may punch and/or emboss a sheet member with the rectangular corner of the sheet member being accurately arranged to the corresponding punching region, and one punch pin may be commonly used for both punching regions.

This punch may be used for accurately forming various punching and embossing patterns in a corner portion of a sheet member such as a card, a letter paper, a picture, a board, or a paper, which requires decoration, as well as for punching work in offices or industries.

1. A punch comprising:
a jig having two punching regions symmetrically disposed on the basis of a punching center so that a main pattern hole of a predetermined pattern is formed in one punching region and a convex embossment (or, a concave embossment) is formed on the other punching region;
a base to which the jig is fixed, the base giving a supply surface so that a rectangular corner of a sheet member to be punched is supplied to the punching region;
a punching member having a punch pin and a concave embossment (or, a convex embossment) corresponding to the pattern hole and the convex embossment (or, the concave embossment), the punching member punching and/or embossing the rectangular corner of the supplied sheet member with moving up and down against the jig; and
an elastic body interposed between the punching member and the jig to elastically bias the punching member upward.

2. A punch according to claim 1,
wherein a guide is formed on an upper surface of the base in order to guide both edges of the rectangular corner so that the rectangular corner of the sheet member is put into each punching region of the jig.

3. A punch according to claim 1, further comprising:
a button member combined above the punching member for acting as a contact portion pressed by hand; and
a cap for wrapping the button member, the punching member and the elastic body.

4. A punch according to any of claims 1 to 3,
wherein the jig additionally has an edge pattern hole formed integrally over both punching regions of the jig so that an edge portion of the rectangular corner of the sheet member supplied to each punching region is punched,
wherein the punching member further includes an edge punch pin corresponding to the edge punch hole.

5. A punch according to claim 4, wherein the edge punch pin includes:
a first cutting blade for cutting the edge portion of the sheet member supplied to one punching region along a predetermined punching line; and
a second cutting blade for cutting the edge portion of the sheet member supplied to the other punching region, the second cutting blade cutting a point between a virtual punching line symmetrical to an edge punching line of one punching region on the basis of the punching center and a central line passing through the punching center and crossing a midway of both punching lines.

6. A punch according to claim 5,
wherein the second cutting blade is positioned between the virtual punching line and the central line and has a curved shape for cutting along a virtual arc passing through the punching center.
